(19) United States
(12) Patent Application Publication
(10) Pub. No.: US 2025/0276507 A1
(43) Pub. Date: Sep. 4, 2025

(54) RETORTABLE PACKAGING FILM

(71) Applicant: Amcor Flexibles North America, Inc., Neenah, WI (US)

(72) Inventors: Bert De Schoenmaker, Laarne (BE); Sara Menghetti, Cecina (IT)

(21) Appl. No.: 18/863,622

(22) PCT Filed: May 26, 2022
(86) PCT No.: PCT/US2022/031040

§ 371 Date: Nov. 6, 2024

(51) Int. Cl. B32B 27/08; B32B 27/32; B65D 75/00; B65D 75/26

(52) U.S. Cl. CPC B32B 27/08; B32B 27/32; B65D 75/008; B65D 75/26; B32B 2250/242; B32B 2255/10; B32B 2255/20; B32B 2255/205; B32B 2270/00; B32B 2307/30; B32B 2307/31; B32B 2307/518; B32B 2307/7242; B32B 2439/46

(57) ABSTRACT

A retortable packaging film is disclosed. The retortable packaging film includes a laminate including a BOPP film and an MDOPP film. The retortable packaging film further includes a sealing layer disposed on the laminate. The sealing layer includes a blend including a polypropylene terpolymer and a long-chain branched polyethylene selected from the group consisting of LDPE and MDPE. The sealing layer has a melt flow index in a range of from 5 g/10 min to 25 g/10 min according to ASTM D1238 Procedure A Condition 230° C./2.16 kg. The retortable packaging film further includes a total composition including at least 80% polypropylene, by weight.

### TECHNICAL FIELD

The present application relates generally to a retortable packaging film, a hermetically sealed packaged food product including the retortable packaging film, and a method to produce the retortable packaging film.

### BACKGROUND

Retortable packages, such as stand-up pouches, are typically made from multi-polymer laminates, such as PET/OPA/PP (polyester/oriented polyamide/polypropylene) and PET/ALU/PP (polyester/aluminum/polypropylene). However, due to the presence of materials, such as PET, ALU, and OPA, such multi-polymer laminates may not be compliant with certain recycling guidelines (e.g., CEFLEX).

For compliance with the recycling guidelines, mono-polymer laminates (e.g., PE or PP based laminates) may be used for making the retortable packages. However, making the retortable packages from the mono-polymer laminates may pose several challenges. For example, the retortable packages may need to possess a high seal strength and be robust enough for retort processing while exhibiting straight tearing properties in one direction for facilitating opening of the retortable packages.

Conventionally, the straight tearing properties are typically imparted onto the multi-polymer laminates via a scoring process (e.g., laser scoring). However, scores made from such scoring processes may be visible features that can detrimentally affect an aesthetic appearance of the retortable packages made from the multi-polymer laminates. Scoring may also be unfeasible for the mono-polymer laminates. Additionally, the mono-polymer laminates may need to be heat sealed at relatively low temperatures (e.g., from 120° C. to 140° C.) so that the mono-polymer laminates do not get damaged (e.g., melted, warped, or marred).

Therefore, there is a need for a retortable packaging film that includes high levels of polyolefin (i.e., greater than 80% or 90%, by weight) to meet the recycling guidelines, that possesses a high seal strength and is robust enough for retort processing, and that exhibits straight tearing properties in one direction for facilitating opening of the retortable packages without the need of visible features (e.g., scores) that can be detrimental to an aesthetic appearance of the retortable packages.

### SUMMARY

A retortable packaging film has been developed. The retortable packaging film includes a mono-polymer laminate and therefore may be compliant with certain recycling guidelines. Furthermore, the mono-polymer laminate may provide adequate robustness to the retortable packaging film in order to withstand retort and other high temperature sterilization processing.

The retortable packaging film further includes a sealing layer disposed on the mono-polymer laminate. The sealing layer may provide a high seal strength at a low seal initiation temperature. In other words, the retortable packaging film may be sealed at relatively low temperatures (e.g., from 120° C. to 140° C.) and provide a high seal strength (e.g., greater than 10 N/15 mm) that may be essential for retort processing. The mono-polymer laminate may be resilient and not get damaged due to heat sealing by way of having a low seal initiation temperature.

The sealing layer may be suitable for extrusion coating onto the mono-polymer laminate and may be unsuitable for blown film extrusion and cast film extrusion. Specifically, the sealing layer may be designed for and may be suitable for extrusion coating. The sealing layer may not be ideal for blown film extrusion and cast film extrusion. Sealing layers that are designed for and are suitable for blown film extrusion typically have a melt flow index below 5 g/10 min and are not suitable for a sealing layer of the present invention. Sealing layers that are designed for and are suitable for cast film extrusion typically have a melt flow index below 10 g/10 min or below 7 g/10 min and are not suitable for a sealing layer of the present invention.

The retortable packaging film may exhibit straight tearing properties (e.g., along a machine direction). The straight tearing properties may be provided by an orientation of one or more films of the mono-polymer laminate. As a result, the retortable packaging film may exhibit the straight tearing properties without use of scores or any visible features. Therefore, any graphics or other appearance features that may be printed on a retortable package made from the retortable packaging film may be free of disruption from such scores or visible features. This may improve an aesthetic appearance of the retortable package.

The straight tearing properties may facilitate opening of the retortable package made from the retortable packaging film. Advantageously, the sealing layer may not negatively affect the straight tearing properties of the retortable packaging film while having a low seal initiation temperature.

The retortable packaging film may be compliant with recycling guidelines, may possess a high seal strength and may be robust enough for retort processing, and may exhibit straight tearing properties in one direction (e.g., a machine direction) for facilitating opening of a retortable package made from the retortable packaging film.

One embodiment of the present disclosure is a retortable packaging film. The retortable packaging film includes a laminate including a biaxially oriented polypropylene (BOPP) film and a machine direction oriented polypropylene (MDOPP) film. The retortable packaging film further includes a sealing layer disposed on the laminate. The sealing layer includes a blend including a polypropylene terpolymer and a long-chain branched polyethylene selected from the group consisting of low density polyethylene (LDPE) and medium density polyethylene (MDPE). The sealing layer has a melt flow index in a range of from 5 g/10 min to 25 g/10 min according to ASTM D1238 Procedure A Condition 230° C./2.16 kg. The retortable packaging film further includes a total composition including at least 80% polypropylene, by weight.

The sealing layer may provide a high seal strength at a low seal initiation temperature. In other words, the retortable packaging film may be sealed at relatively low temperatures (e.g., from 120° C. to 140° C.) and provide a high seal strength (e.g., greater than 10 N/15 mm) that may be essential for retort processing. The laminate including the BOPP film and the MDOPP film may not get damaged due to heat sealing at the relatively low temperatures.

The sealing layer may be suitable for extrusion coating and may be unsuitable for blown film extrusion and cast film extrusion. Specifically, the melt flow index (i.e., between 5 g/10 min and 25 g/10 min at 230° C./2.16 kg) of the sealing layer may make the sealing layer suitable for extrusion coating. The sealing layer may not be ideal for blown film extrusion and cast film extrusion. Sealing layers that are designed for and are suitable for blown film extrusion typically have a melt flow index below 5 g/10 min and are not suitable for a sealing layer of the present invention. Sealing layers that are designed for and are suitable for cast film extrusion typically have a melt flow index below 10 g/10 min or below 7 g/10 min and are not suitable for a sealing layer of the present invention.

The retortable packaging film may exhibit straight tearing properties (e.g., along a machine direction). The straight tearing properties may be provided by the MDOPP film of the laminate. Advantageously, the retortable packaging film may exhibit the straight tearing properties without use of scores or any visible features. Therefore, any graphics or other appearance features that may be printed on a retortable package made from the retortable packaging film may be free of disruption from such scores or visible features. This may improve an aesthetic appearance of the retortable package.

The straight tearing properties may facilitate opening of the retortable package made from the retortable packaging film. Advantageously, the sealing layer may not negatively affect the straight tearing properties of the retortable packaging film while having a low seal initiation temperature.

The retortable packaging film may be compliant with recycling guidelines, as the total composition of the retortable packaging film includes at least 80% polypropylene, by weight. Further, the retortable packaging film may be robust enough for retort processing. The retortable packaging film may possess a high seal strength due to the sealing layer. Advantageously, the sealing layer may provide the high seal strength at a low seal initiation temperature such that the laminate does not get melted, warped, or marred. Further, the retortable packaging film may exhibit straight tearing properties in one direction (e.g., a machine direction) for facilitating opening of a retortable package made from the retortable packaging film.

In some embodiments, the blend of the sealing layer includes between 4% and 50% of the long-chain branched polyethylene, by weight, and between 50% and 90% of the polypropylene terpolymer, by weight.

In some embodiments, the polypropylene terpolymer has a melting temperature above 130° C.

In some embodiments, the sealing layer has a seal initiation temperature less than 140° C. as measured using ASTM F88 Technique A.

In some embodiments, the melt flow index of the sealing layer is between 5 g/10 min and 15 g/10 min according to ASTM D1238 Procedure A Condition 230° C./2.16 kg.

In some embodiments, the sealing layer is not oriented. The sealing layer being not oriented may allow the sealing layer to have a low seal initiation temperature.

In some embodiments, the sealing layer is extrusion coated onto the laminate. The melt flow index of the sealing layer may make the sealing layer suitable for extrusion coating. The melt flow index of the sealing layer may make the sealing layer unsuitable for blown film extrusion and cast film extrusion.

In some embodiments, the laminate further includes a barrier layer attached to the BOPP film or the MDOPP film. The barrier layer may impart various barrier properties to the retortable packaging film, such as moisture barrier properties, gas barrier properties, and/or odor barrier properties.

In some embodiments, the barrier layer includes one of a metal layer or an oxide coating layer deposited on a surface of the BOPP film or the MDOPP film.

In some embodiments, the barrier layer includes a polymeric barrier material.

In some embodiments, the total composition includes at least 90% polypropylene, by weight.

In some embodiments, the total composition includes less than 20% non-polyolefin materials, by weight.

In some embodiments, the total composition includes less than 10% non-polyolefin materials, by weight.

In some embodiments, the MDOPP film is located on an exterior surface of the retortable packaging film.

In some embodiments, the BOPP film is located on an exterior surface of the retortable packaging film.

Another embodiment of the present disclosure is a hermetically sealed packaged food product. The hermetically sealed packaged food product includes the retortable packaging film. The hermetically sealed packaged food product may be recycling compliant and may possess the straight tearing properties of the retortable packaging film. As a result, the hermetically sealed packaged food product may be easily opened when desired.

Another embodiment of the present disclosure is a method to produce a retortable packaging film. The method includes lamination of a BOPP film to an MDOPP film to form a pre-laminate. The method further includes extrusion coating a sealing layer onto the pre-laminate. The sealing layer includes a blend including a polypropylene terpolymer and a long-chain branched polyethylene selected from the group consisting of LDPE and MDPE. The sealing layer has a melt flow index between 5 g/10 min and 25 g/10 min according to ASTM D1238 Procedure A Condition 230° C./2.16 kg.

Another embodiment of the present disclosure is a method to produce a retortable packaging film. The method includes extruding and machine direction orienting a film to produce an MDOPP film. The method further includes extrusion coating a sealing layer onto the MDOPP film. The method further includes applying a barrier coating to a BOPP film. The method further includes adhesive laminating the MDOPP film and the BOPP film. The sealing layer includes a blend including a polypropylene terpolymer and a long-chain branched polyethylene selected from the group consisting of LDPE and MDPE. The sealing layer has a melt flow index between 5 g/10 min and 25 g/10 min according to ASTM D1238 Procedure A Condition 230° C./2.16 kg.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic cross-sectional view of a retortable packaging film in accordance with an embodiment of the present disclosure;

FIG. 2 is a schematic cross-sectional view of a retortable packaging film in accordance with another embodiment of the present disclosure;

FIG. 3 is a schematic cross-sectional view of a retortable packaging film in accordance with another embodiment of the present disclosure;

FIG. 4 is a schematic cross-sectional view of a retortable packaging film in accordance with another embodiment of the present disclosure;

FIG. 5 is a schematic cross-sectional view of a retortable packaging film in accordance with another embodiment of the present disclosure;

FIG. 6 is a schematic front view of a hermetically sealed packaged food product in accordance with an embodiment of the present disclosure;

FIG. 7 is a flowchart depicting various steps of a method to produce a retortable packaging film in accordance with an embodiment of the present disclosure; and

FIG. 8 is a flowchart depicting various steps of a method to produce a retortable packaging film in accordance with another embodiment of the present disclosure.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

A retortable packaging film has been developed. The retortable packaging film includes a laminate including a BOPP film and an MDOPP film. The retortable packaging film further includes a sealing layer disposed on the laminate. The sealing layer includes a blend including a polypropylene terpolymer and a long-chain branched polyethylene selected from the group consisting of LDPE and MDPE. The sealing layer has a melt flow index between 5 g/10 min and 25 g/10 min according to ASTM D1238 Procedure A Condition 230° C./2.16 kg. The retortable packaging film further includes a total composition including at least 80% polypropylene, by weight.

The sealing layer may provide a high seal strength at a low seal initiation temperature. In other words, the retortable packaging film may be sealed at relatively low temperatures (e.g., from 120° C. to 140° C.) and provide a high seal strength (e.g., greater than 10 N/15 mm) that may be essential for retort processing. The laminate including the BOPP film and the MDOPP film may not get damaged due to heat sealing at relatively low temperatures. The laminate may be resilient and not get damaged due to heat sealing by way of having sealing layer with a low seal initiation temperature.

The sealing layer may be suitable for extrusion coating and may be unsuitable for blown film extrusion and cast film extrusion. Specifically, the melt flow index (i.e., between 5 g/10 min and 25 g/10 min at 230° C./2.16 kg) of the sealing layer may make the sealing layer suitable for extrusion coating and may make the sealing layer unsuitable for blown film extrusion processing. The melt flow index of the sealing layer may further make the sealing layer unsuitable for cast film extrusion processing. In other words, the sealing layer may not be ideal for blown film extrusion and cast film extrusion. Sealing layers that are designed for and are suitable for blown film extrusion typically have a melt flow index below 5 g/10 min and are not suitable for a sealing layer of the present invention. Sealing layers that are designed for and are suitable for cast film extrusion typically have a melt flow index below 10 g/10 min or below 7 g/10 min and are not suitable for a sealing layer of the present invention.

The retortable packaging film may exhibit straight tearing properties (e.g., along a machine direction). The straight tearing properties may be provided by the MDOPP film of the laminate. Advantageously, the retortable packaging film may exhibit the straight tearing properties without the inclusion of scores or any other visible features. Therefore, any graphics or other appearance features that may be printed on a retortable package made from the retortable packaging film may be free of disruption from such scores or visible features. This may improve an aesthetic appearance of the retortable package.

The straight tearing properties may facilitate opening of a retortable package made from the retortable packaging film. Advantageously, the sealing layer may not negatively affect the straight tearing properties of the retortable packaging film while having a low seal initiation temperature.

The retortable packaging film may be compliant with recycling guidelines, as the total composition of the retortable packaging film includes at least 80% polypropylene, by weight. Further, the retortable packaging film may be robust enough for retort processing. The retortable packaging film may possess a high seal strength due to the sealing layer. Advantageously, the sealing layer may provide the high seal strength at a low seal initiation temperature such that the laminate does not get melted, warped, or marred. Further, the retortable packaging film may exhibit straight tearing properties in one direction (e.g., a machine direction) for facilitating opening of a retortable package made from the retortable packaging film.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, the term “film” is a material with a very high ratio of a length or a width to a thickness. A film has two major surfaces defined by a length and a width. Films typically have good flexibility and can be used for a wide variety of applications. Films may also be of suitable thickness and/or material composition such that they are flexible, semi-rigid, or rigid. Films may be described as monolayer or multilayer.

As used herein, the terms “interior” and “exterior” refer to the major surfaces of a film or a layer.

As used herein, the term “retort process” refers to a process in which a food, medical, or other item packaged in a flexible package may be heated to a high temperature (e.g., from 104° C. to 149° C. or from 120° C. to 135° C.) for an extended period of time, for example, from 10 to 60 minutes, under high pressure (such as in the presence of water, steam, or pressurized steam). The term “retort process” may also include other high temperature sterilization processes, such as hot-fill.

As used herein, the term “retortable package” refers to a package that is hermetically sealed and capable of maintaining its hermetically-sealed state during a retort process. For example, a retortable package may maintain its hermetically-sealed state during cooking of a food composition hermetically-sealed within the retortable package. The term “retortable packaging film” refers to a film that can be used to form the retortable package.

As used herein, the term “laminate” refers to a product made by bonding together two or more films or other materials. Laminates may be made by any lamination methods. For example, lamination may be accomplished by joining films together with adhesives, joining with heat and pressure, and even spread coating and extrusion coating. The term “laminate” is also inclusive of coextruded multilayer films including one or more adhesive layers.

As used herein, the term “pre-laminate” refers to a laminate onto which one or more polymeric layers may be coated, adhered, or otherwise attached.

As used herein, the term “BOPP film” refers to a biaxially oriented polypropylene film. A BOPP film is a polypropylene film that has been subjected to a stretching process in a machine direction and a transverse direction.

As used herein, the term “MDOPP film” refers to a machine direction oriented polypropylene film. An MDOPP film is a polypropylene film that has been subjected to a stretching process in a machine direction.

As used herein, the term “sealing layer” refers to a layer of a film, sheet, etc., involved in the sealing of the film, sheet, etc., to itself and/or to another layer of the same or another film, sheet, etc.

As used herein, the term “terpolymer” refers to a copolymer produced from three different monomers. The term “polypropylene terpolymer” refers to a polypropylene molecular chain modified with two additional co-monomers in the polymerization process. Examples of the two additional co-monomers may include ethylene and/or C4-C16 α-olefins, ethylene and/or C4-C8 α-olefins, and ethylene and butylene.

As used herein, the term “low density polyethylene” or “LDPE” refers to branched homopolymers that typically have densities between 0.910 g/cm³ and 0.930 g/cm³, as well as copolymers containing polar groups resulting from copolymerization (such as with vinyl acetate or ethyl acrylate).

As used herein, the term “medium density polyethylene” or “MDPE” refers to branched homopolymers that typically have densities between 0.928 g/cm³ and 0.940 g/cm³. Medium density polyethylene includes linear medium density polyethylene (LMDPE).

As used herein, the term “melt flow index” or “MFI” refers to a measure of the ease of flow of the melt of a polymer. Melt flow index means the amount, in grams, of a resin which can be forced through a plastometer or rheometer (as defined in ASTM D1238) in ten minutes at a given temperature and force.

As used herein, the term “melting temperature” or “Tm” refers to the temperature at which a solid and a liquid phase of a material may coexist in equilibrium.

As used herein, the term “seal initiation temperature” refers to a sealing temperature at which a seal strength of approximately 5 N/15 mm is achieved. Seal initiation temperature may be evaluated using ASTM F88.

As used herein, the term “oriented” refers to a film, sheet, web, etc., which has been elongated in at least one of a machine direction and a transverse direction. The term “non-oriented” or “not oriented” refers to a film, sheet, web, etc., that is substantially free of post-formation orientation.

As used herein, the term “extrusion coating” refers to a process of applying a melt state coating material onto at least a portion of a substrate, optionally under pressure and/or at an elevated temperature.

As used herein, the term “barrier layer” refers to a layer of a film including any material which controls a permeable element of the film. A barrier layer may provide, for example, oxygen barrier, moisture barrier, chemical barrier, heat barrier, and/or odor barrier.

As used herein, the term “adhesive layer” refers to a layer which has a primary function of bonding two adjacent layers together. The adhesive layer may be positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material. Adhesive layers may alternatively be referred to as “tie layers”.

As used herein, the term “polyethylene” refers to a homopolymer or copolymer having at least one ethylene monomer linkage within the repeating backbone of the polymer. The ethylene linkage can be represented by the general formula: [CH₂—CH₂]ₙ. Polyethylenes may be formed by any method known to those skilled in the art.

As used herein, the term “polyolefin” refers to a polymer with the general formula (CH₂CHR)ₙ, where R is an alkyl group. The term “non-polyolefin material” or “non-olefin material” refers to any material that is not a polyolefin. For example, a non-polyolefin material may include a polyamide, a polyester, a styrene, a polyurethane, and the like.

As used herein, the term “mono-polymer laminate” refers to a laminate including a total composition including a single polymer type in a substantial amount (e.g., above 80%, 90% or 95%, by total weight of the laminate).

As used herein, the term “straight tearing properties” refer to properties of a film, sheet, web, etc., that allow the film, sheet, web, etc., to easily tear in a substantially straight line.

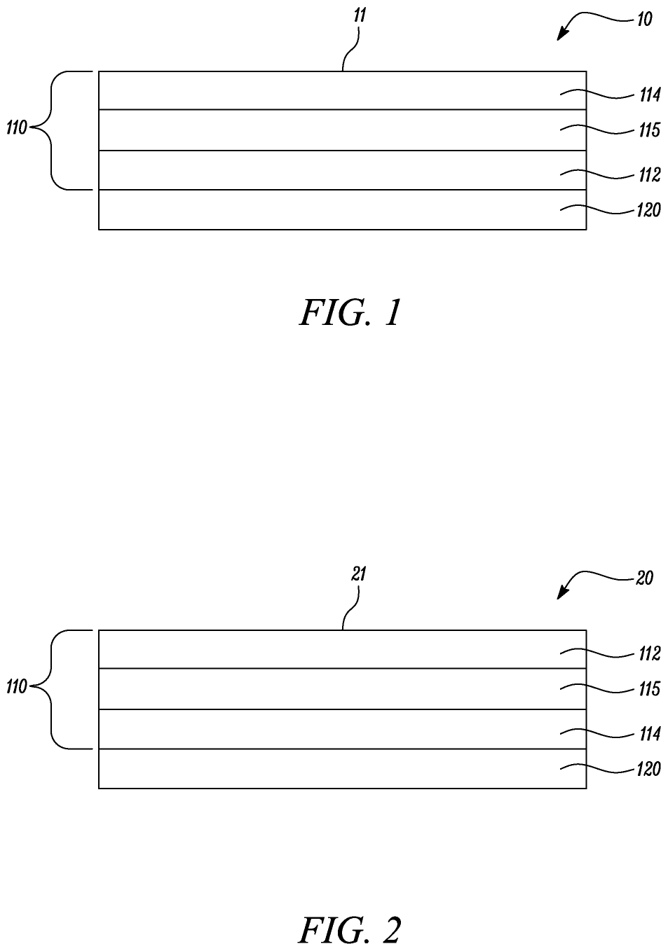

FIG. 1 shows a schematic cross-sectional view of a retortable packaging film 10 in accordance with an embodiment of the present disclosure.

Retortable packaging film 10 includes a laminate 110. Laminate 110 includes an MDOPP film 112 and a BOPP film 114. Laminate 110 may be formed by any suitable lamination method, such as co-extrusion, adhesive lamination, and the like.

In the illustrated embodiment of FIG. 1, laminate 110 further includes an adhesive layer 115 disposed between MDOPP film 112 and BOPP film 114. Adhesive layer 115 may bond BOPP film 114 to MDOPP film 112. Adhesive layer 115 may include any suitable adhesive, for example, water-soluble adhesives, radiation curable or heat-curable adhesives, hot melt adhesives, and pressure sensitive adhesives. Examples of these aforementioned adhesive materials include polyacrylates, acrylic emulsions, polyurethanes, polyamides, reaction products of polyamide with vegetable oil acids, epoxies, ethyleneamines, polysiloxanes, silicone rubber, polyalkylene glycols, polyesters, sulfopolyesters, etc. It may be noted that adhesive layer 115 is optional and may be omitted from laminate 110, for example, if laminate 110 is formed using a lamination method that does not utilize an adhesive.

Retortable packaging film 10 further includes a sealing layer 120 disposed on laminate 110. Sealing layer 120 includes a blend including a polypropylene terpolymer and a long-chain branched polyethylene selected from the group consisting of LDPE and MDPE. In some embodiments, the blend of sealing layer 120 includes between 4% and 50% of the long-chain branched polyethylene, by weight, and between 50% and 90% of the polypropylene terpolymer, by weight. In some embodiments, the polypropylene terpolymer has a melting temperature above 130° C.

Sealing layer 120 has a melt flow index in a range from 5 g/10 min to 25 g/10 min according to ASTM D1238 Procedure A Condition 230° C./2.16 kg. In some embodiments, the melt flow index of sealing layer 120 is in a range from 5 g/10 min to 15 g/10 min according to ASTM D1238 Procedure A Condition 230° C./2.16 kg. In some embodiments, the melt flow index of sealing layer 120 is in a range from 7 g/10 min to 25 g/10 min according to ASTM D1238 Procedure A Condition 230° C./2.16 kg. In some embodiments, the melt flow index of sealing layer 120 is in a range from 10 g/10 min to 25 g/10 min according to ASTM D1238 Procedure A Condition 230° C./2.16 kg. In some embodiments, the melt flow index of sealing layer 120 is in a range from 7 g/10 min to 15 g/10 min according to ASTM D1238 Procedure A Condition 230° C./2.16 kg. In some embodiments, the melt flow index of sealing layer 120 is in a range from 10 g/10 min to 15 g/10 min according to ASTM D1238 Procedure A Condition 230° C./2.16 kg.

This melt flow index of sealing layer 120 may make it suitable for some processes and may make it unsuitable for other processes. Table 1 provides melt flow index ranges of typical polyethylene grades by process. The melt flow index ranges in Table 1 are taken from “The Science and Technology of Flexible Packaging: Multilayer Films from Resin and Process to End Use” by Barry A. Morrison.

TABLE 1
Melt flow index ranges of typical polyethylene grades by process

| | Typical melt flow index range for |
|---|---|
| Process | polyethylene, g/10 min (190° C./2.16 kg) |
| Blown Film | 1-5 |
| Blown Film (HDPE) | 0.01-1 |
| Cast Film | 2-7 |
| Extrusion Coating | 4-15 |

As depicted by Table 1, the melt flow index of sealing layer 120 (between 5 g/10 min and 25 g/10 min at 230° C./2.16 kg) may make sealing layer 120 suitable for extrusion coating on laminate 110. Therefore, in some embodiments, sealing layer 120 is extrusion coated on laminate 110. Further, such melt flow index of sealing layer 120 may make sealing layer 120 unsuitable for blown film extrusion and cast film extrusion. Sealing layers that are designed for and are suitable for blown film extrusion typically have a melt flow index below 5 g/10 min and are not suitable for use as sealing layer 120. Sealing layers that are designed for and are suitable for cast film extrusion typically have a melt flow index below 10 g/10 min or below 7 g/10 min and are not suitable for use as sealing layer 120.

Sealing layer 120 may provide a high seal strength (e.g., a seal strength of greater than 5 Newton/15 millimeters or more), which may be important for retort applications. Furthermore, sealing layer 120 may have a low seal initiation temperature. For example, sealing layer 120 may have a seal initiation temperature in a range of 100° C. to 140° C. or in a range of 120° C. to 140° C. In some embodiments, sealing layer 120 has a seal initiation temperature less than 140° C. as measured using ASTM F88 Technique A. In some embodiments, sealing layer 120 is not oriented. Sealing layer 120 being not oriented may allow sealing layer 120 to have a low seal initiation temperature.

BOPP film 114 may provide sufficient stiffness to retortable packaging film 10 for packaging applications. However, laminate 110 including MDOPP film 112 and BOPP film 114 may not have a high heat resistance. Therefore, laminate 110 may be prone to defects upon being subjected to high temperatures during heat sealing.

Sealing layer 120 may enable retortable packaging film 10 to be heat sealed at a low temperature (e.g., at 125° C.), such that laminate 110 may not get melted, warped, marred. Consequently, retortable packaging film 10 may be heat sealed without detrimentally affecting laminate 110.

Retortable packaging film 10 may exhibit straight tearing properties (e.g., along a machine direction). The straight tearing properties may be provided by MDOPP film 112 of laminate 110. Therefore, a retortable package formed by retortable packaging film 10 may also exhibit the straight tearing properties for facilitating opening of the retortable package. Advantageously, retortable packaging film 10 may exhibit the straight tearing properties without use of scores or any visible features. Therefore, any graphics or other appearance features that may be printed on the retortable package may be free of disruption from such scores or visible features. This may improve an aesthetic appearance of the retortable package.

Retortable packaging film 10 includes a total composition including at least 80% polypropylene, by weight. Consequently, in some embodiments, the total composition includes less than 20% non-polyolefin materials, by weight. In some embodiments, the total composition includes at least 90% polypropylene, by weight. Consequently, in some embodiments, the total composition includes less than 10% non-polyolefin materials, by weight.

In the illustrated embodiment of FIG. 1, BOPP film 114 is located on an exterior surface 11 of retortable packaging film 10. In other words, BOPP film 114 defines exterior surface 11 of retortable packaging film 10. Exterior surface 11 may be opposite to sealing layer 120. Exterior surface 11 may form an exterior surface of a package formed using retortable packaging film 10. Moreover, in the illustrated embodiment of FIG. 1, sealing layer 120 is disposed on MDOPP film 112. Sealing layer 120 may be extrusion coated on MDOPP film 112.

FIG. 2 shows a schematic cross-sectional view of a retortable packaging film 20 in accordance with another embodiment of the present disclosure. Retortable packaging film 20 is similar to retortable packaging film 10 of FIG. 1, with like elements designated by like reference characters. However, retortable packaging film 20 has a different configuration of laminate 110 as compared to retortable packaging film 10.

Specifically, in the illustrated embodiment of FIG. 2, MDOPP film 112 is located on an exterior surface 21 of retortable packaging film 20. In other words, MDOPP film 112 defines exterior surface 21 of retortable packaging film 20. Exterior surface 21 may be opposite to sealing layer 120. Exterior surface 21 may form an exterior surface of a package formed using retortable packaging film 20. Moreover, in the illustrated embodiment of FIG. 2, sealing layer 120 is disposed on BOPP film 114. Sealing layer 120 may be extrusion coated on BOPP film 114.

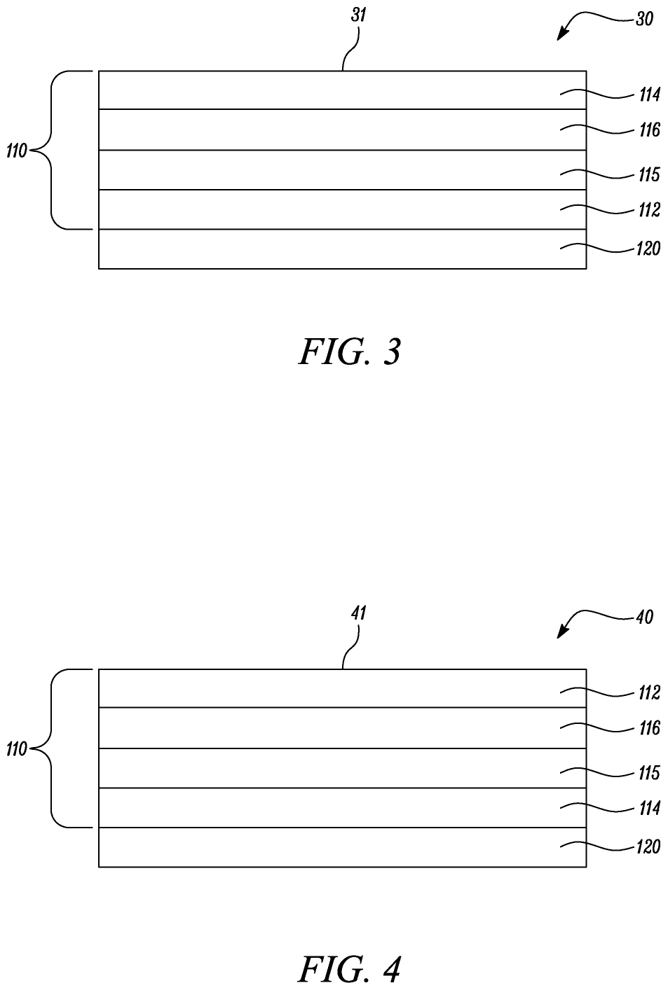

FIG. 3 shows a schematic cross-sectional view of a retortable packaging film 30 in accordance with another embodiment of the present disclosure. Retortable packaging film 30 is similar to retortable packaging film 10 of FIG. 1, with like elements designated by like reference characters. However, retortable packaging film 30 has a different configuration of laminate 110 as compared to retortable packaging film 10.

In some embodiments, laminate 110 further includes a barrier layer 116 attached to MDOPP film 112 or BOPP film 114. It may be noted that barrier layer 116 is optional and may be omitted from laminate 110 based upon desired application attributes. In the illustrated embodiment of FIG. 3, barrier layer 116 is attached to BOPP film 114.

Barrier layer 116 may provide desired barrier properties to retortable packaging film 30. For example, barrier layer 116 may provide gas (e.g., oxygen) barrier properties, moisture barrier properties, and/or odor barrier properties to retortable packaging film 30.

In some embodiments, barrier layer 116 includes a metal layer or an oxide coating layer deposited on a surface of MDOPP film 112 or BOPP film 114. In the illustrated embodiment of FIG. 3, the metal layer or the oxide coating layer is deposited on a surface of BOPP film 114. The metal layer of barrier layer 116 may include, for example, a foil (e.g., aluminum foil). The oxide coating layer of barrier layer 116 may include, for example, aluminum oxide, silicon oxide, metalized polyethylene terephthalate, and the like.

In some embodiments, barrier layer 116 includes a polymeric barrier material. The polymeric barrier material may include, but is not limited to, ethylene-vinyl alcohol (EVOH) copolymers; polyvinyl alcohol (PVOH) copolymers; poly(vinyl chloride); polyvinylidene polymers and copolymers, including polyvinylidene chloride; polyamides including amorphous polyamides; acrylonitrile polymers, including acrylonitrile-methyl acrylate copolymers; polyurethane engineering plastics; poly(methyl pentene) resins; ethylene-carbon monoxide copolymers; liquid crystal polymers; polyesters such as polyethylene terephthalate; polyimides, including polyether imides and polyacrylic imides; and other such polymeric materials known to have relatively low gas transmission rates. Blends and grafts of these aforementioned materials, such as combinations of polyimides and crystalline polymers such as liquid crystal polymers, polyamides and polyethylene terephthalate, and combinations of polyamides with styrenics may also be suitable for use as the polymeric barrier material.

In the illustrated embodiment of FIG. 3, BOPP film 114 is located on an exterior surface 31 of retortable packaging film 30. In other words, BOPP film 114 defines exterior surface 31 of retortable packaging film 30. Exterior surface 31 may be opposite to sealing layer 120. Exterior surface 31 may form an exterior surface of a package formed using retortable packaging film 30.

In the illustrated embodiment of FIG. 3, adhesive layer 115 is disposed between MDOPP film 112 and barrier layer 116. Moreover, in the illustrated embodiment of FIG. 3, sealing layer 120 is disposed on MDOPP film 112. Sealing layer 120 may be extrusion coated on MDOPP film 112.

FIG. 4 shows a schematic cross-sectional view of a retortable packaging film 40 in accordance with another embodiment of the present disclosure. Retortable packaging film 40 is similar to retortable packaging film 30 of FIG. 3, with like elements designated by like reference characters. However, retortable packaging film 40 has a different configuration of laminate 110 as compared to retortable packaging film 30.

Specifically, in the illustrated embodiment of FIG. 4, MDOPP film 112 is located on an exterior surface 41 of retortable packaging film 40. In other words, MDOPP film 112 defines exterior surface 41 of retortable packaging film 40. Exterior surface 41 may be opposite to sealing layer 120. Exterior surface 41 may form an exterior surface of a package formed using retortable packaging film 40. Furthermore, in the illustrated embodiment of FIG. 4, barrier layer 116 is attached to MDOPP film 112.

In the illustrated embodiment of FIG. 4, adhesive layer 115 is disposed between BOPP film 114 and barrier layer 116. Moreover, in the illustrated embodiment of FIG. 4, sealing layer 120 is disposed on BOPP film 114. Sealing layer 120 may be extrusion coated on BOPP film 114.

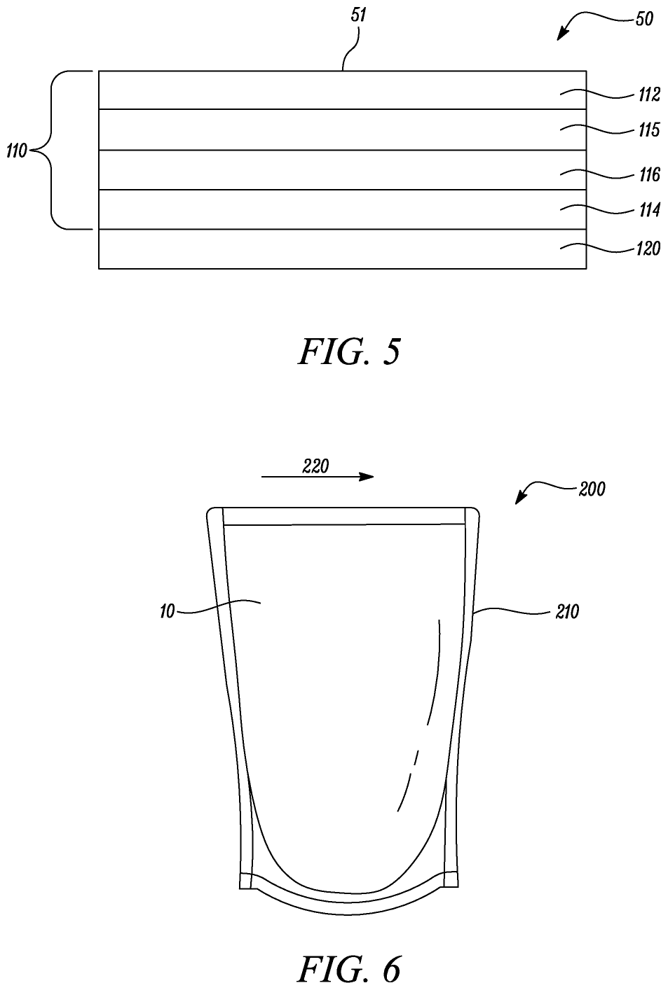

FIG. 5 shows a schematic cross-sectional view of a retortable packaging film 50 in accordance with another embodiment of the present disclosure. Retortable packaging film 50 is similar to retortable packaging film 40 of FIG. 4, with like elements designated by like reference characters. However, retortable packaging film 50 has a different configuration of laminate 110 as compared to retortable packaging film 40.

Specifically, in the illustrated embodiment of FIG. 5, barrier layer 116 is disposed on BOPP film 114 opposite to sealing layer 120. Further, in the illustrated embodiment of FIG. 5, adhesive layer 115 is disposed between MDOPP film 112 and barrier layer 116.

In the illustrated embodiment of FIG. 5, MDOPP film 112 is located on an exterior surface 51 of retortable packaging film 50. In other words, MDOPP film 112 defines exterior surface 51 of retortable packaging film 50. Exterior surface 51 may be opposite to sealing layer 120. Exterior surface 51 may form an exterior surface of a package formed using retortable packaging film 50.

FIG. 6 shows a schematic front view of a hermetically sealed packaged food product 200 in accordance with an embodiment of the present disclosure.

Hermetically sealed packaged food product 200 may include a retortable package 210 and a food product (not shown) packaged inside retortable package 210. In the illustrated embodiment of FIG. 6, retortable package 210 is a stand up pouch. However, it may be noted that retortable package 210 may be any suitable type of flexible package.

In the illustrated embodiment of FIG. 6, hermetically sealed packaged food product 200 includes retortable packaging film 10 of FIG. 1. Specifically, retortable package 210 may include retortable packaging film 10. In other words, retortable package 210 may be made from retortable packaging film 10. In some other embodiments, hermetically sealed packaged food product 200 may include retortable packaging film 20 of FIG. 2, retortable packaging film 30 of FIG. 3, retortable packaging film 30 of FIG. 3, retortable packaging film 40 of FIG. 4, or retortable packaging film 50 of FIG. 5.

Referring to FIGS. 1 and 6, retortable packaging film 10 may be hermetically heat sealed to form retortable package 210. As a result, retortable package 210 may be suitable for undergoing a retort process. Advantageously, retortable package 210 may exhibit straight tearing properties along an opening direction 220. Opening direction 220 may correspond to the machine direction of MDOPP film 112 of retortable packaging film 10. As a result, retortable package 210 may be easily torn along opening direction 220 to access the food product packaged therein. Advantageously, implements, such as a pair of scissors, may not be required to open retortable package 210.

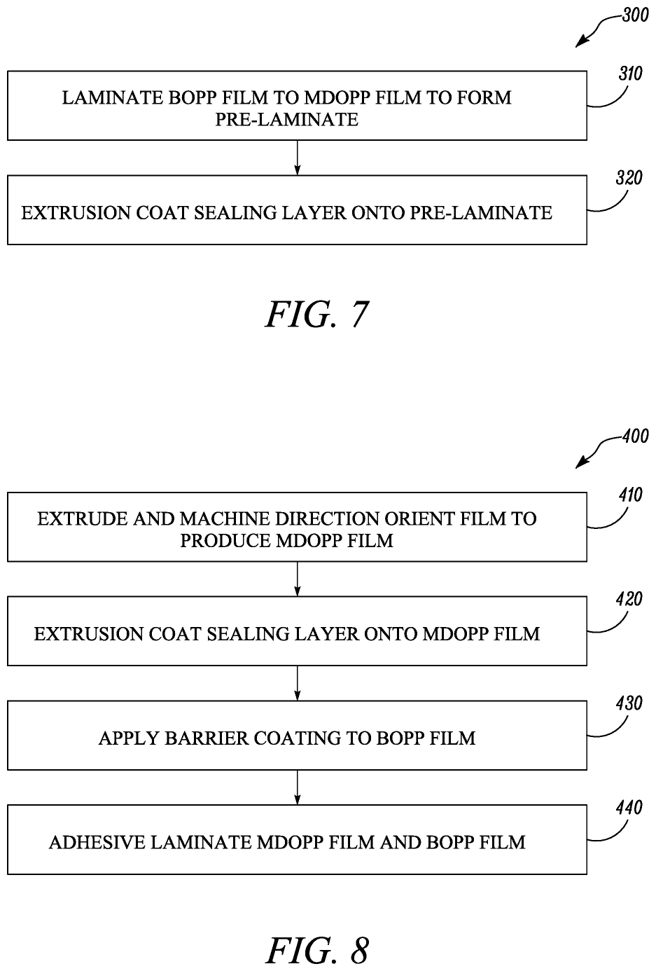

FIG. 7 shows a flowchart depicting various steps of a method 300 to produce a retortable packaging film in accordance with an embodiment of the present disclosure. For example, method 300 may be used to produce retortable packaging film 10 of FIG. 1, retortable packaging film 20 of FIG. 2, retortable packaging film 30 of FIG. 3, retortable packaging film 40 of FIG. 4, or retortable packaging film 50 of FIG. 5.

At step 310, method 300 includes laminating a BOPP film to an MDOPP film to form a pre-laminate. Referring to FIGS. 1 and 7, for example, method 300 may include laminating MDOPP film 112 to BOPP film 114 to form laminate 110. The pre-laminate may have any suitable configuration, such as configurations of laminate 110 described above with reference to FIGS. 1-5.

At step 320, method 300 further includes extrusion coating a sealing layer onto the pre-laminate. The sealing layer includes a blend including a polypropylene terpolymer and a long-chain branched polyethylene selected from the group consisting of LDPE and MDPE. The sealing layer has a melt flow index between 5 g/10 min and 25 g/10 min according to ASTM D1238 Procedure A Condition 230° C./2.16 kg. Referring to FIGS. 1 and 7, for example, method 300 may include extrusion coating sealing layer 120 onto laminate 110. Sealing layer 120 may include the blend including the polypropylene terpolymer and the long-chain branched polyethylene selected from the group consisting of LDPE and MDPE. Further, sealing layer 120 may have the melt flow index between 5 g/10 min and 25 g/10 min according to ASTM D1238 Procedure A Condition 230° C./2.16 kg.

Method 300 may allow production of the retortable packaging film in a simple and economical manner.

FIG. 8 shows a flowchart depicting various steps of a method 400 to produce a retortable packaging film in accordance with an embodiment of the present disclosure. For example, method 400 may be used to produce retortable packaging film 30 of FIG. 3.

At step 410, method 400 includes extruding and machine direction orienting a film to produce an MDOPP film. Referring to FIGS. 3 and 8, for example, method 400 may include extruding and machine direction orienting a film to produce MDOPP film 112.

At step 420, method 400 further includes extrusion coating a sealing layer onto the MDOPP film. Referring to FIGS. 3 and 8, for example, method 400 may include extrusion coating sealing layer 120 onto MDOPP film 112.

At step 430, method 400 further includes applying a barrier coating to a BOPP film. Referring to FIGS. 3 and 8, for example, method 400 may include applying barrier layer 116 to BOPP film 114.

At step 440, method 400 further includes adhesive laminating the MDOPP film and the BOPP film. Referring to FIGS. 3 and 8, for example, method 400 may include adhesive laminating MDOPP film 112 and the BOPP film 114.

The sealing layer includes a blend including a polypropylene terpolymer and a long-chain branched polyethylene selected from the group consisting of LDPE and MDPE. The sealing layer has a melt flow index between 5 g/10 min and 25 g/10 min according to ASTM D1238 Procedure A Condition 230° C./2.16 kg. Referring to FIGS. 3 and 8, for example, sealing layer 120 may include the blend including the polypropylene terpolymer and the long-chain branched polyethylene selected from the group consisting of LDPE and MDPE. Further, sealing layer 120 may have the melt flow index between 5 g/10 min and 25 g/10 min according to ASTM D1238 Procedure A Condition 230° C./2.16 kg.

Method 400 may allow production of the retortable packaging film in a simple and economical manner.

### EXAMPLES

In the following examples, the following test protocols were used.
Melt flow index-units: g/10 min, ASTM D1238, test at 230° C. using 2.16 kg, unless otherwise noted. Melt flow index (MFI) may be interchangeably referred to as melt flow rate (MFR).
Seal strength, ASTM F88-seal using a two side heated sealing bar, 0.5 seconds, 400 N/cm² pressure, seal to itself, peel in the machine direction, peel on a tensile unit at 300 mm/min, 15 mm width.
The seal initiation temperature is the sealing temperature at which a seal strength of approximately 5 N/15 mm is achieved.
Tear strength, Trouser tear test, machine direction, ASTM D1938. This test may further indicate straight tearing properties of films.

### COMPARATIVE EXAMPLES

Two sample films were produced to demonstrate the detrimental effects that orientation of a sealing layer can have on the seal initiation temperature. A three layer film was made by cast coextrusion, the sealing layer having a blend of 67% polypropylene terpolymer (Tm=131° C., MFR=6.0 g/10 min), 25% thermoplastic polyolefin copolymer (Tm=142° C., MFR=0.6 g/10 min), 5% homopolymer polypropylene, and 3% antiblock masterbatch. This film was laminated to two BOPP films to create a first three-ply laminate structure. Upon heat sealing this film, it was found that the laminate had a seal initiation temperature of about 121° C. and a seal strength of 16.9 N/15 mm when sealed at 130° C. These seal properties are highly desirable for retort packaging. The film had a tear strength (Trouser tear) of about 1.6 N, which is acceptable. However, this laminate structure has very poor straight tear performance.

The second laminate was produced by first machine direction orienting (3:1 stretch) the three layer cast coextrusion film described above, then laminating this MDO film to two BOPP films to create a second three-ply laminate structure. Upon heat sealing this film, it was found that the laminate had a seal initiation temperature of about 134° C. and a seal strength of less than 1 N/15 mm at 130° C. This demonstrates that while orientation of the sealing film may assist in tear property performance, the detriment to the heat seal initiation temperature is unacceptable. The stretch ratio for this film was 3:1. It would be possible to improve the tear performance of this film by increasing the stretch ratio (i.e., 5:1). However, this change would have a further detrimental effect on the seal performance due to the orientation of the sealing layer.

### INVENTION EXAMPLES

A film laminate was produced with the structure of [BOPP/adhesive/MDOPP/extrusion coated sealant]. The MDO film comprised a random PP, stretched to a 5:1 ratio, having a final thickness of 30 microns. The sealant was applied by extrusion coating at a weight of 24 g/m². The sealant was a blend of 65% (by weight) polypropylene terpolymer (Tm=131° C., MFR=6.0 g/10 min), 20% LDPE with long chain branching (MFR=3.8 g/10 min at 190° C., Tm=108° C.), 10% homopolymer polypropylene (MFR=25 g/10 min ISO 1133), and 5% random copolymer polypropylene (density=0.88 g/cm³, MFR=6 g/10 min at 230° C./2.16 kg). The measured MFR of the sealant blend was 7.7 g/10 min. Upon heat sealing this film, it was found that the seal initiation temperature was about 125° C. This laminate exhibited straight tear, and a Trouser tear value of 2.05 N. This film had a total composition including 3.5% polyethylene, 94.2% polypropylene, 97.7% polyolefin and 2.3% non-olefin material (adhesive). It is noted that if the MDOPP film were further optimized for sealing (such as the MDOPP film used in the comparative example above) an even lower Trouser tear value could be achieved.

A film laminate was produced to demonstrate the effectiveness of introducing an MDOPP film into the laminate and using extrusion coating to apply the sealing layer. The final laminate structure was BOPP/adhesive/MDOPP/sealant. The MDOPP film was a three layer coextruded film, stretched 5× in the machine direction, having a final thickness of 30 microns. The MDOPP film had a core layer containing 100% homopolymer polypropylene, and surface layers of 80% heterophasic polypropylene block copolymer and 20% of a random copolymer polypropylene (density=0.88 g/cm³, MFR=6 g/10 min at 230° C./2.16 kg). The sealant was applied by extrusion coating at a weight of 24 g/m². The sealant was a blend of about 50% polypropylene terpolymer (Tm=131° C., MFR=9 g/10 min), about 25% random copolymer polypropylene, about 20.5% polypropylene, and about 4.5% long-chain branched LDPE. The melt flow rate of the sealant blend was calculated to be about 12.2 g/10 min (at 230° C./2.16 kg). Upon heat sealing this film, it was found that the laminate had a seal initiation temperature of about 123° C. and a seal strength of 13.7 N/15 mm at 130° C. The laminate also had advantageous machine direction tear properties, clean straight tear, and 1.2 N in the Trouser tear test. This film had a total composition including 3.2% polyethylene, 94.5% polypropylene, 97.7% polyolefin and 2.3% non-olefin material (adhesive). This demonstrates that an optimized MDOPP and an extrusion coated sealant delivers the desired combination of retort-appropriate seals and good machine direction tear.

Each and every document cited in this present application, including any cross referenced, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

Unless otherwise indicated, all numbers expressing sizes, amounts, ranges, limits, and physical and other properties used in the present application are to be understood as being preceded in all instances ay the term “about”. Accordingly, unless expressly indicated to the contrary, the numerical parameters set forth in the present application are approximations that can vary depending on the desired properties sought to be obtained by a person of ordinary skill in the art without undue experimentation using the teachings disclosed in the present application.

As used in the present application, the singular forms “a”, “an”, and “the” encompass embodiments having plural referents, unless the context clearly dictates otherwise. As used in the present application, the term “or” is generally employed in its sense including “and/or”, “unless” the context clearly dictates otherwise.

Spatially related terms, including but not limited to, “lower”, “upper”, “beneath”, “below”, “above”, “bottom” and “top”, if used in the present application, are used for ease of description to describe spatial relationships of an element(s) to another. Such spatially related terms encompass different orientations of the device in use or operation, in addition to the particular orientations depicted in the figures and described in the present application. For example, if an object depicted in the drawings is turned over or flipped over, elements previously described as below, or beneath other elements would then be above those other elements.

The drawings show some but not all embodiments. The elements depicted in the drawings are illustrative and not necessarily to scale, and the same (or similar) reference numbers denote the same (or similar) features throughout the drawings.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

### Retortable Packaging Film Embodiments

A. A retortable packaging film comprising:
a laminate comprising:
a BOPP film, and
an MDOPP film, and
a sealing layer disposed on the laminate and comprising a blend including a polypropylene terpolymer and a long-chain branched polyethylene selected from the group consisting of LDPE and MDPE, the sealing layer having a melt flow index in a range from 5 g/10 min to 25 g/10 min according to ASTM D1238 Procedure A Condition 230° C./2.16 kg, and
a total composition comprising at least 80% polypropylene, by weight.

B. The retortable packaging film according to any other retortable packaging film embodiment, wherein the blend of the sealing layer comprises between 4% and 50% of the long-chain branched polyethylene, by weight, and between 50% and 90% of the polypropylene terpolymer, by weight.

C. The retortable packaging film according to any other retortable packaging film embodiment, wherein the polypropylene terpolymer has a melting temperature above 130° C.

D. The retortable packaging film according to any other retortable packaging film embodiment, wherein the sealing layer has a seal initiation temperature less than 140° C. as measured using ASTM F88 Technique A.

E. The retortable packaging film according to any other retortable packaging film embodiment, wherein the melt flow index of the sealing layer is in a range from 5 g/10 min to 15 g/10 min according to ASTM D1238 Procedure A Condition 230° C./2.16 kg.

F. The retortable packaging film according to any other retortable packaging film embodiment, wherein the sealing layer is not oriented.

G. The retortable packaging film according to any other retortable packaging film embodiment, wherein the sealing layer is extrusion coated onto the laminate.

H. The retortable packaging film according to any other retortable packaging film embodiment, wherein the laminate further comprises a barrier layer attached to the BOPP film or the MDOPP film.

I. The retortable packaging film according to embodiment H, wherein the barrier layer comprises a metal layer or an oxide coating layer deposited on a surface of the BOPP film or the MDOPP film.

J. The retortable packaging film according to embodiment H, wherein the barrier layer comprises a polymeric barrier material.

K. The retortable packaging film according to any other retortable packaging film embodiment, wherein the total composition comprises at least 90% polypropylene, by weight.

L. The retortable packaging film according to any other retortable packaging film embodiment, wherein the total composition comprises less than 20% non-polyolefin materials, by weight.

M. The retortable packaging film according to any other retortable packaging film embodiment, wherein the total composition comprises less than 10% non-polyolefin materials, by weight.

N. The retortable packaging film according to any of embodiments A through M, wherein the MDOPP film is located on an exterior surface of the retortable packaging film.

O. The retortable packaging film according to any of embodiments A through M, wherein the BOPP film is located on an exterior surface of the retortable packaging film.

### Hermetically Sealed Packaged Food Product Embodiment

P. A hermetically sealed packaged food product comprising the retortable packaging film of any of embodiments A through O.

### Method Embodiments

Q. A method to produce a retortable packaging film, the method comprising:
laminating a BOPP film to an MDOPP film to form a pre-laminate, and
extrusion coating a sealing layer onto the pre-laminate,
wherein the sealing layer comprises a blend including a polypropylene terpolymer and a long-chain branched polyethylene selected from the group consisting of LDPE and MDPE, the sealing layer having a melt flow index in a range from 5 g/10 min to 25 g/10 min according to ASTM D1238 Procedure A Condition 230° C./2.16 kg.

R. A method to produce a retortable packaging film, the method comprising:
extruding and machine direction orienting a film to produce an MDOPP film;
extrusion coating a sealing layer onto the MDOPP film;
applying a barrier coating to a BOPP film; and
adhesive laminating the MDOPP film and the BOPP film;
wherein the sealing layer comprises a blend including a polypropylene terpolymer and a long-chain branched polyethylene selected from the group consisting of LDPE and MDPE, the sealing layer having a melt flow index in a range from 5 g/10 min to 25 g/10 min according to ASTM D1238 Procedure A Condition 230° C./2.16 kg.

1. A retortable packaging film comprising:
a laminate comprising:
a BOPP film, and
an MDOPP film, and
a sealing layer disposed on the laminate and comprising a blend including a polypropylene terpolymer and a long-chain branched polyethylene selected from the group consisting of LDPE and MDPE, the sealing layer having a melt flow index in a range of from 5 g/10 min to 25 g/10 min according to ASTM D1238 Procedure A Condition 230° C./2.16 kg, and
a total composition comprising at least 80% polypropylene, by weight.

2. The retortable packaging film according to claim 1, wherein the blend of the sealing layer comprises between 4% and 50% of the long-chain branched polyethylene, by weight, and between 50% and 90% of the polypropylene terpolymer, by weight.

3. The retortable packaging film according to claim 1, wherein the polypropylene terpolymer has a melting temperature above 130° C.

4. The retortable packaging film according to claim 1, wherein the sealing layer has a seal initiation temperature less than 140° C. as measured using ASTM F88 Technique A.

5. The retortable packaging film according to claim 1, wherein the melt flow index of the sealing layer is in a range of from 5 g/10 min to 15 g/10 min according to ASTM D1238 Procedure A Condition 230° C./2.16 kg.

6. The retortable packaging film according to claim 1, wherein the sealing layer is not oriented.

7. The retortable packaging film according to claim 1, wherein the sealing layer is extrusion coated onto the laminate.

8. The retortable packaging film according to claim 1, wherein the laminate further comprises a barrier layer attached to the BOPP film or the MDOPP film.

9. The retortable packaging film according to claim 8, wherein the barrier layer comprises a metal layer or an oxide coating layer deposited on a surface of the BOPP film or the MDOPP film.

10. The retortable packaging film according to claim 8, wherein the barrier layer comprises a polymeric barrier material.

11. The retortable packaging film according to claim 1, wherein the total composition comprises at least 90% polypropylene, by weight.

12. The retortable packaging film according to claim 1, wherein the total composition comprises less than 20% non-polyolefin materials, by weight.

13. The retortable packaging film according to claim 1, wherein the total composition comprises less than 10% non-polyolefin materials, by weight.

14. The retortable packaging film according to claim 1, wherein the MDOPP film is located on an exterior surface of the retortable packaging film.

15. The retortable packaging film according to claim 1, wherein the BOPP film is located on an exterior surface of the retortable packaging film.

16. A hermetically sealed packaged food product comprising the retortable packaging film of claim 1.

17. (canceled)

18. (canceled)
